(19) United States
(12) Patent Application Publication
(10) Pub. No.: US 2025/0152468 A1
(43) Pub. Date: May 15, 2025

(54) CONTROL DEVICE DETECTION FOR POOL OR SPA SYSTEMS

(71) Applicant: Zodiac Pool Systems LLC, Carlsbad, CA (US)

(72) Inventors: Darin Eames, Carlsbad, CA (US); Minas Minassian, Carlsbad, CA (US); Eusebio Domingo Bareng, Carlsbad, CA (US); Sandra Morrison, Carlsbad, CA (US); Jeremy Young, Carlsbad, CA (US)

(73) Assignee: Zodiac Pool Systems LLC, Carlsbad, CA (US)

(21) Appl. No.: 18/941,608

(22) Filed: Nov. 8, 2024

Related U.S. Application Data
(60) Provisional application No. 63/599,417, filed on Nov. 15, 2023.

(51) Int. Cl. A61H 33/00; E04H 4/14

(52) U.S. Cl. CPC A61H 33/005; E04H 4/14; A61H 2033/0079; A61H 2033/0083; A61H 2201/5015; A61H 2201/5082

(57) ABSTRACT

Systems and methods for control device detection for pool or spa systems are disclosed. In an example method, a computing system outputs, to a first electrical port, a test signal. The computing system determines an electrical measurement for the first electrical port using the test signal. The computing system identifies a first control device for a first piece of pool or spa equipment based on the electrical measurement. The computing device records first information about the first control device.

### CROSS-REFERENCE TO RELATED APPLICATION

This application claims priority to provisional application U.S. Ser. No. 63/599,417 entitled “Discrete Load Power Sensing In Pool Or Spa Systems” and filed on Nov. 15, 2023, the entire disclosure of which is incorporated herein by reference for any purpose.

### FIELD

The present disclosure relates generally to pool or spa systems and more particularly, although not exclusively, to control device detection for pool or spa systems.

### BACKGROUND

Pool and spa systems may be in service for decades. As a result of relatively long lifespans, pool and spa systems may include components with varying levels of features. For instance, some components may be smart components, which may be able to digitally report information about themselves to a pool automation controller. Conversely, some components may simply be controlled by an input current and may not be able to digitally report information about themselves to a pool automation controller.

### SUMMARY

In one general aspect, a pool automation controller for detecting electrical components of a pool or spa system includes one or more electrical ports, each electrical port configured to receive a connection to a control device associated with a piece of pool or spa equipment, one or more non-transitory computer-readable media; and one or more processors communicatively coupled to the one or more non-transitory computer-readable media, the one or more processors configured to execute processor-executable instructions stored in the non-transitory computer-readable media to perform operations including outputting, to a first electrical port, a test signal. The operations further include determining an electrical measurement for the first electrical port using the test signal. The operations further include identifying a first control device for a first piece of pool or spa equipment based on the electrical measurement. The operations further include recording first information about the first control device.

In another general aspect, a method includes outputting, to a first electrical port, a test signal. The method further includes determining an electrical measurement for the first electrical port using the test signal. The method further includes identifying a first control device for a first piece of pool or spa equipment based on the electrical measurement. The method further includes recording first information about the first control device.

In another general aspect, a non-transitory computer-readable medium storing processor-executable instructions is configured to cause one or more processors to output, to a first electrical port, a test signal. The non-transitory computer-readable medium storing processor-executable instructions is further configured to cause the one or more processors to determine an electrical measurement for the first electrical port using the test signal. The non-transitory computer-readable medium storing processor-executable instructions is further configured to cause the one or more processors to identify a first control device for a first piece of pool or spa equipment based on the electrical measurement. The non-transitory computer-readable medium storing processor-executable instructions is further configured to cause the one or more processors to record first information about the first control device.

### BRIEF DESCRIPTION OF THE DRAWINGS

FIG. 1 illustrates a pool system controlled by a pool automation controller, according to some examples of the present disclosure.

FIG. 2 illustrates an example flow diagram showing a process for control device detection for pool or spa systems, according to some examples of the present disclosure.

FIG. 3 illustrates an example flow diagram showing another process for control device detection for pool or spa systems, according to some examples of the present disclosure.

FIG. 4 illustrates an example flow diagram showing another for control device detection for pool or spa systems, according to some examples of the present disclosure.

FIG. 5 illustrates examples of components of a computer system used for control device detection for pool or spa systems, according to some examples of the present disclosure.

FIG. 6 illustrates a pool system controlled by a pool automation controller for control device detection for pool or spa systems, according to some examples of the present disclosure.

FIG. 7 illustrates an example flow diagram showing a process for equipment detection and identification using load sensing for pool or spa systems, according to some examples of the present disclosure.

FIG. 8 illustrates an example flow diagram showing a process for equipment detection and identification using a combination of techniques for pool or spa systems, according to some examples of the present disclosure.

### DETAILED DESCRIPTION

Examples described herein relate to systems, devices, and techniques for control device detection for pool or spa systems. A pool or spa system may include a pool automation controller. A pool automation controller can manage various pool and spa functions, such as water temperature, lighting, pump operation, and any other suitable function. The controller may receive input from sensors, as well as user commands via a suitable user interface (“UI”), to automate certain functions, which can improve the user experience and minimize burdens on pool or spa owners or operators such as maintenance or conservation efforts. Such functionality can be achieved by connecting various pieces of pool or spa equipment to the pool automation controller.

Pool or spa equipment can be connected to the pool automation controller using a number of different techniques. For example, the pool automation controller may be connected to pool or spa equipment using digital interfaces such as an RS-485 serial interface or an Ethernet interface for sending and receiving TCP/IP packets. In another example, the pool automation controller may be connected to a number of control devices for controlling pool or spa equipment. For example, the pool automation controller may include relays or be connected to relays. Relays, in this context, can refer generally to electrically operated switches that control high-power devices such as pumps, filters, heaters, lights, and so on. Relays may include electromechanical relays, solid-state relays, or other kinds of relays. Relays can be activated by the pool automation controller to start, stop, or change the mode of operation of connected equipment by closing, opening, or changing the state of circuits. Likewise, valves included in pool or spa equipment can be controlled using the pool automation controller using electromechanical valve actuators. Other types of control devices may include pressure sensors, proximity switches, float switches, limit switches, and the like.

Relay- or actuator-operated pool or spa equipment can be connected to the pool automation controller via one or more ports. A port, in this context, can refer generally to a terminal for connecting control devices to the pool automation controller. For instance, the ports may be sockets including a number of terminals (e.g., one terminal and a common ground, two terminals, three terminals including one ground terminal, etc.). Terminals may include sockets, screws, outlets, and so on.

While some pool or spa equipment connected via certain digital interfaces may be capable of outputting information to identify the particular piece of equipment, operating status (e.g., on or off), mode of operation (e.g., pump speed), etc., pool or spa equipment connected via the one or more ports may lack such capabilities. For example, a relay-controlled heater may be connected to a particular port, but the pool automation controller may require manual updating of a pool or spa system status to correctly indicate the presence of the heater and to provide control functions via the pool automation controller user interface (“UI”). The pool or spa system status may refer generally to a map or similar representation of the pool or spa system including indications of connected equipment, control devices, and associated functionality and controls. In the event the heater is removed or transferred to another port, the system status must again be manually updated. Manual management of a pool automation controller for a complex pool or spa system can quickly become untenable, error-prone, and arduous.

These challenges can be addressed using the techniques for control device detection for pool or spa systems disclosed herein. For example, the pool automation controller can detect and record the presence of pool or spa equipment connected to the one or more ports. For instance, the pool automation controller may detect a relay by measuring current flow after sending a test signal to the relay. The pool automation controller may also detect a valve actuator by measuring current flow after sending a test signal to the valve actuator. In some examples, the pool automation controller can identify particular pieces of pool or spa equipment based on information derived from electrical connections to the control devices their respective ports or using information about power consumption obtained using components for power consumption measurement included in the pool automation controller. The pool automation controller may detect and record the presence of relays and other control devices on a recurring schedule or after specific events, such as a restart of the pool automation controller. After recording the presence of relays and components, the pool automation controller may provide control and role assignment of the relays and components as recorded in a system status using a user interface.

Connected pool or spa equipment can likewise be detected using other means such as via digital interface or through detection of a higher-power load using an induced current generated by inductive coils. In general, connections to a pool or spa system may be grouped according to power consumption. For example, a first group may include low power loads (e.g., 3 horsepower (“HP”) relays or other equipment with current in the few tens of mA). These examples may include electrical loads that are used to activate or control other, higher-power loads. A second group may include medium power loads (e.g., valve actuators or loads connected at the output of solenoid relays at 24 VAC). A third group may include high power loads (e.g., non-digitally connected pumps such as a spa blower pump).

Various approaches can be used to determine that equipment is connected to the pool automation controller and/or to identify such connected equipment. For example, the current flow and/or voltage drop technique described above may be suitable to detect loads from the first and second groups. Load sensing using an induced current may be suitable for detecting loads from the third group. In contrast, the current flow and/or voltage drop techniques may be unsuitable for detecting the loads in the third group, while load sensing may be less suitable for detecting loads from the first and second groups because the measuring circuitry may not be able to detect these loads.

The following illustrative method is provided to introduce certain concepts relating to the current flow and/or voltage drop techniques. In the example method, a computing system such as a processing subsystem included in a pool automation controller, outputs, to an electrical port, a test signal. For example, consider a heater situated in a pool connected via a pair of wires to a distant pool automation controller in a nearby shed. The wires come together in a connecting device such as a plug compatible with a socket that is part of the electrical port. The heater can be remotely turned on or off or controlled (e.g., power increased) using an electromechanical relay disposed near the heater.

To determine whether the heater is connected to the electrical port, the computing system can output a command to cause the application of a voltage to the terminals of the electrical port to, in turn, cause a small current to flow in the wires for a short period of time. The computing system then determines an electrical measurement for the electrical port using the test signal. For example, the small current, or absence thereof, can be measured. Similarly, a voltage drop across the terminals of the electrical port can be measured. These or other electrical measurements can be used, by the computing system, to identify the connected control device—the relay, in this example—for the heater.

The computing system then records information about the identified control device. For example, the computing system can update a locally stored system status including a map of all connected pieces of pool or spa equipment, power sources, control devices, bodies of water, and so on. The system status can likewise include the operating status (e.g., on or off), mode of operation (e.g., pump speed) of each piece of pool or spa equipment. In some examples, the system status can be generated or updated automatically based on information obtained during determination of the electrical measurement.

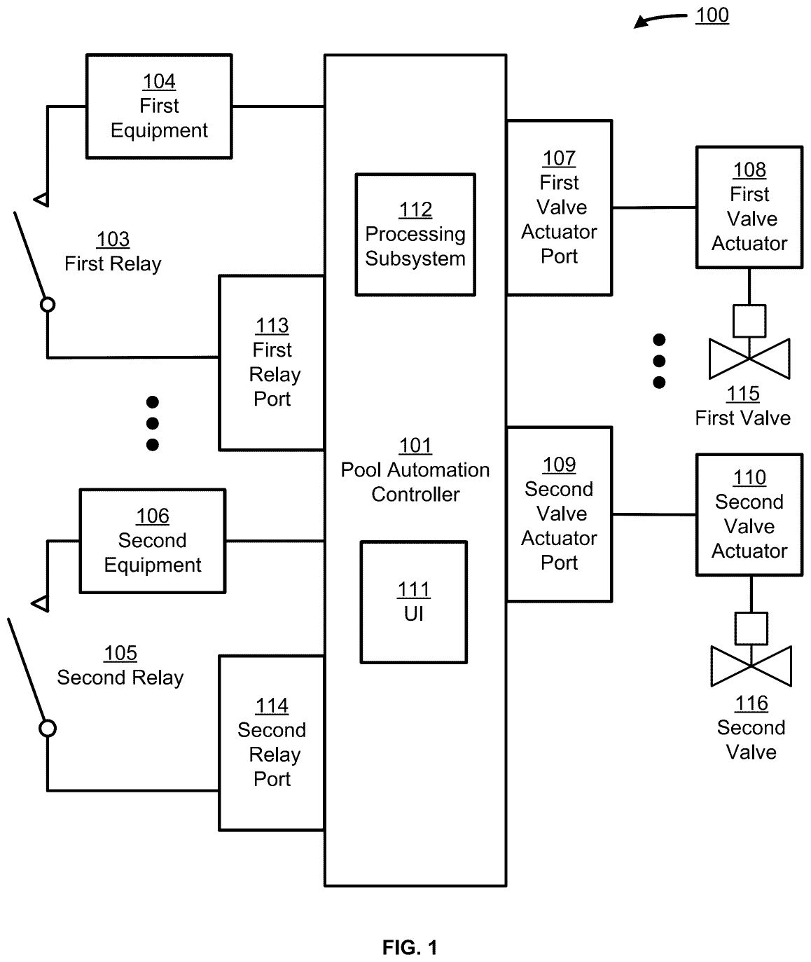

Turning now to the figures, FIG. 1 illustrates a pool system 100 controlled by a pool automation controller 101, according to some examples of the present disclosure. The pool automation controller 101 may be connected, via one or more ports, to any suitable number of relays, valve actuators, and other control devices. Other control devices may include solenoids, contactors, pressure or limit switches, and so on.

The pool automation controller 101 includes processing subsystem 112. The processing subsystem may include one or more processors that are communicatively coupled with a memory, such as physical, random-access memory or a hard disk drive. The memory can include one or more non-transitory computer-readable media that include processor-executable instructions to perform various operations for the control and operation of the pool automation controller.

The processing subsystem 112 of the pool automation controller 101 may periodically, based on some triggering event (e.g., at initial boot up, at every reboot, etc.), or in any other suitable manner execute instructions to identify control devices connected to the pool automation controller 101 and powered by the pool or spa system. For example, this may include pool or spa equipment whose activation or mode of operation is controlled by the relays, actuators, and other control devices connected to the pool automation controller 101. The processing subsystem 112 can also execute instructions to communicate with components that are digitally connected to the pool automation controller 101 (e.g., those that are connected via a bus, that that include a digital connection back to the pool automation controller 101, or those that do have any other network connection with the pool automation controller 101).

Because these control devices lack a digital connection with the processing subsystem 112 of the pool automation controller 101, the processing subsystem 112 of the pool automation controller 101 may have no way of obtaining information about the control devices, unless that information is derived and confirmed. The techniques described herein may include techniques for the pool automation controller 101 to identify these types of control devices and enable a user to determine, confirm, or infer how they are laid out in a pool or spa system. For example, the techniques may use a set of test signals to identify a set of valve actuators connected to a corresponding set of ports in the pool automation controller 101. This information can be used to populate a system status maintained by a management application (e.g., on the pool automation controller 101, within a smartphone, hosted by a server and available over the Internet, etc.) including a user interface for configuring the pool or spa system (e.g., identifying where the valves are located in the system and their functions). This may lead to reduced setup time, reduced customer confusion, and increased customer satisfaction.

In the example illustrated in FIG. 1, the pool automation controller 101 is shown controlling a first piece of pool or spa equipment 104 and a second piece of pool or spa equipment 106 (labeled as “first equipment 105” and “second equipment 106,” respectively, for visual clarity). The pool automation controller 101 is also controlling a first valve 115 and a second valve 116.

The first and second valves 115, 116 are remotely operated using the first and second valve actuators 108, 110. The first and second valve actuators 108, 110 may be, for example, electric motor-driven actuators that can be used for valve opening and closing as well as precision valve positioning. In some examples, a Jandy valve actuator is an example of the valve actuators 108, 110. The first and second valve actuators 108, 110 can thus be used to start, stop, or regulate the flow of water, water pressure, and other system properties. The first and second valve actuators 108, 110 each is connected with the pool automation controller 101 via a respective first valve actuator port 107 and a second valve actuator port 109. The first and second valve actuator ports 107, 109 may be, for example, 3-wire terminal blocks, tip-ring-sleeve (“TRS”) jacks, two- or three-terminal plugs or sockets, and so on.

The pool automation controller 101 is also connected to a first piece of pool or spa equipment 104 and a second piece of pool or spa equipment 106 via first relay 103 and second relay 105, respectively. As with the valve actuators, the first relay 103 is connected to the pool automation controller 101 by way of first relay port 113 and the second relay 105 is connected to the pool automation controller 101 by way of the second relay port 114. In alternate examples, additional relays, components, and valve actuators may be connected to the pool automation controller 101.

To determine the presence of connected pool or spa equipment, the pool automation controller 101 may send a test signal to the first relay 103 to detect the first relay 103 via the first relay port 113. For example, the test signal may correspond to an actual activation voltage that either drives the first relay 103 (e.g., powers a relay coil for an electromechanical relay) or drives the load switched by the first relay 103 (e.g., the first piece of pool or spa equipment 104). In some examples, the pool automation controller 101 may send the test signal by cycling the voltage so rapidly that the first relay 103 and/or the load do not activate but allow for voltage drop detection. Thus, the test signal may be designed to detect the first relay 103 without actually switching the first relay 103, but rather as a pulse that is sufficient to activate but is time limited (e.g., a short pulse). The short pulse may, for instance, have a low amplitude and duration, optimized to avoid latching the first relay 103, with a pulse width in the microsecond or millisecond range and a current level just below the relay's activation threshold, sufficient to induce a measurable voltage drop without engaging the relay's switching mechanism. In some such examples, the test signal may provide enough of a current to create a voltage drop at the pool automation controller 101 from the presence of the first relay 103 on its respective circuit. The pool automation controller 101 may identify the first relay 103 by the current drop or voltage drop resulting from the test signal.

In some examples, the pool automation controller 101 may also detect that the first piece of pool or spa equipment 104 is connected to the first relay 103. Depending on the implementation, such detecting may also involve the pool automation controller 101 switching on the first relay 103 to identify a type of electrical component or other properties of the first piece of pool or spa equipment 104 based on changes between a pulse sent to the respective first piece of pool or spa equipment 104 (via the first relay 103) and a response received from the first piece of pool or spa equipment 104. The pool automation controller 101 may also record information about the first piece of pool or spa equipment 104 and the first relay 103. The pool automation controller 101 may likewise detect the second relay 105 or additional relays with a test signal sufficient to detect a relay without actuating the relay.

The pool automation controller 101 may send a test signal to the first valve actuator port 107 to detect the first valve actuator 108. Like the test signal sent to the relays 103, 105, the test signal for the valve actuator 108 may correspond to an actual drive voltage for the valve actuator 108 but switched very rapidly. In this manner, the test signal may be designed to detect the presence of first valve actuator 108 by detecting a voltage drop or current flow resulting from actuating the first valve actuator 108. The pool automation controller 101 may record the presence of the first valve actuator 108. In some examples, because valve actuators 108, 110 are connected to respective valve actuator ports 107, 109, the pool automation controller 101 may record the components as valve actuators without needing to deduce what type of component is connected. Thus, the test signal response may be used to deduce that a device is indeed connected. In some examples, additional components may be connected to specific ports on the pool automation controller 101, which may allow the pool automation controller 101 to record what type of component is connected without relying on a response from the test signal.

A UI 111 of the pool automation controller 101 may present a user with various questions after the pool automation controller 101 has detected various components in order to update a system status for the pool or spa system. For example, the pool automation controller 101 may detect the first valve actuator 108 and the second valve actuator 110 using the techniques described above. Because the valve actuators are connected to their respective, specific ports 107, 109, the pool automation controller 101 may be certain that two valve actuators are a part of the present pool system after the detecting process. The pool automation controller 101 may ask a user, through the UI 111, to assign roles to each discovered valve actuator 108, 110. For instance, the processing subsystem 112 may maintain a system status reflected represented by a system diagram that can be updated to show the location and/or function of components such as valve actuators 108, 110.

The potential roles selectable or assignable using the UI 111 of the pool automation controller 101 may vary based on what components are detected. In one non-limiting example, the UI 111 may allow the user to assign the first valve actuator 108 as the suction side valve to the pool system 100 while the second valve actuator 110 may be assigned as the pressure side valve to the pool system 100. In an example where a different number of components are detected by the pool automation controller 101, options for assigning components may vary. In some examples, the UI 111 may be provided in a software application that is executed in a user or client device such as a smartphone, tablet, or other device that is remote from the pool automation controller 101, but in network communication with the pool automation controller 101.

In some examples, the pool automation controller 101 may iteratively check for components as a means of fault detection. For example, the pool automation controller 101 may send the test signal on a recurring schedule or after specific events, such as a restart of the pool automation controller 101.

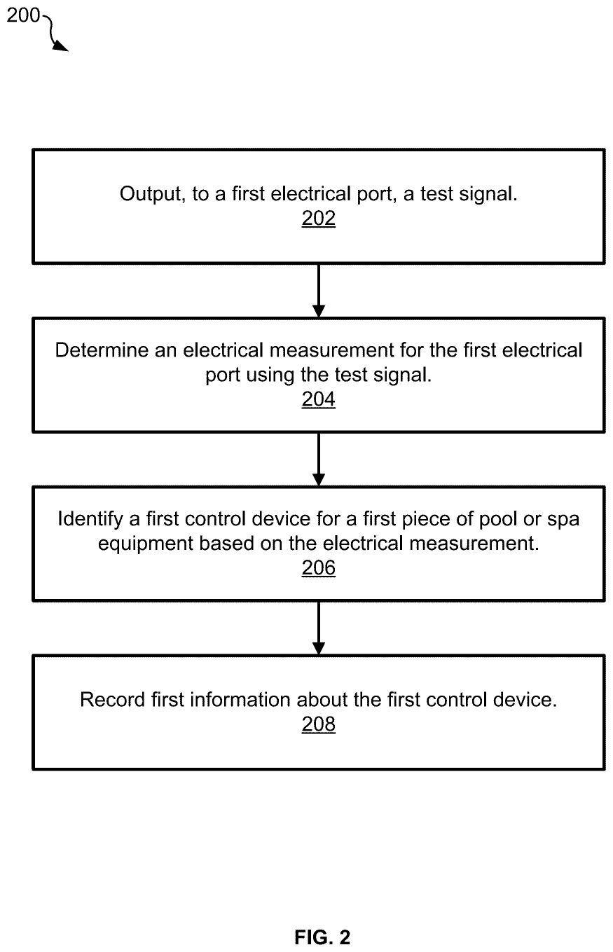

FIG. 2 illustrates an example flow diagram showing a process 200 for control device detection for pool or spa systems, according to some examples of the present disclosure. The process 200 is described from the perspective of a pool automation controller (e.g., the pool automation controller 101 of FIG. 1), but other computing systems such as an external control server or a client device can be used to perform some or all steps of the process 200.

This process, and any other processes described herein, is illustrated as a logical flow diagram, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The process 200 begins at block 202 by the pool automation controller 101 outputting, to a first electrical port, a test signal. The test signal may be characterized by an application of a voltage of a predetermined magnitude to the terminals of the first electrical port. The test signal may be configured to cause a voltage drop or current flow that can be detected by the pool automation controller 101. For example, outputting the test signal may involve applying a predetermined voltage across one or more terminals of the first electrical port to cause a current in a circuit including the one or more terminals of the first electrical port and a first control device, such as the control devices described below.

In alternative embodiments, the voltage drop or current flow resulting from the test signal may be a characteristic of a particular electrical component. For example, particular pieces of pool or spa equipment may have known electrical characteristics that can be determined based on the magnitude of the voltage drop or current flow, the rate of change of the voltage drop or current flow, the characteristics of the changing voltage drop or current flow (e.g., waveform, concavity, frequency, etc.), and so on. The type of pool or spa equipment (e.g., pump, heater, light, etc.) can be inferred or guessed based on these characteristics to aid the user of the pool automation controller 101 when configuring the system status. For example, type may be one of a valve, a pump, a heater, or a light, among many other possible pieces of pool or spa equipment.

The test signal may be, for example, output to the first electrical port in response to a triggering event. The triggering event can include any satisfied or occurred event, condition, or criteria as determined by the processing subsystem 112 or other component of the pool automation controller 101. For instance, the triggering event can include a startup of the pool automation controller 101, an expiration of timer that causes the test signal after a periodically occurring predetermined period of time (e.g., every second, every 10 seconds, every minute, etc.), or a detection of a connection to the first electrical port. In the latter example, the pool automation controller 101 may include components that can detect connections to the ports such as hardware interfaces capable of sensing physical connections, communication protocols that recognize device presence, or circuits designed to monitor and respond to electrical signals indicating connectivity.

In some examples, the test signal may be applied for a predetermined duration. For example, the test signal may be applied for a duration less than the amount of time required to activate the corresponding piece of pool or spa equipment by a control device connected to the first electrical port. In the case of a relay-switched piece of pool or spa equipment such as a pump or a valve actuator, the duration may be a fraction of a section (e.g., 0.1 seconds or 0.01 seconds). In these examples, the duration is chosen such that the applied current is insufficient to cause the corresponding piece of pool or spa equipment to activate (e.g., turn on) or actuate (e.g., change valve positions).

At block 204, the pool automation controller 101 determines an electrical measurement for the first electrical port using the test signal. For example, the electrical measurement for the first electrical port may be a measurement of the current in the circuit or a measurement of a voltage drop based on at least one voltage determined using the one or more terminals of the first electrical port. The electrical measurement can be determined by the processing subsystem 121 given inputs from a number of electrical components or sensors in the pool automation controller 101.

At block 206, the pool automation controller 101 identifies a first control device for a first piece of pool or spa equipment based on the electrical measurement. The first control device may be, for example, a valve actuator associated with a valve configured to direct the flow of water to or from a body of water associated with the pool or spa system. Alternatively, the first control device may be, for example, an electromechanical relay associated a piece of pool or spa equipment such as a pump, a heater, or a light. In this block, identification of the control device may correspond to a determination that a control device is connected to the first electrical port, that a piece of pool or spa equipment is controlled or actuated by the control device, a specific identity or categorization of the piece of pool or spa equipment, or a combination thereof.

In addition to identifying control devices and/or pool or spa equipment based on the electrical measurement, other kinds of pool or spa equipment that are communicatively coupled with the pool automation controller 101 using different kinds of interfaces can likewise be detected or identified. For example, the pool automation controller 101 may include a digital interface such as an Ethernet port, serial port, or parallel port. The pool automation controller 101 can receive information about a piece of pool or spa equipment that is communicatively coupled with the pool automation controller via the digital interface and record information about the digitally connected piece of pool or spa equipment that is likewise useable to update the system status for the pool or spa system.

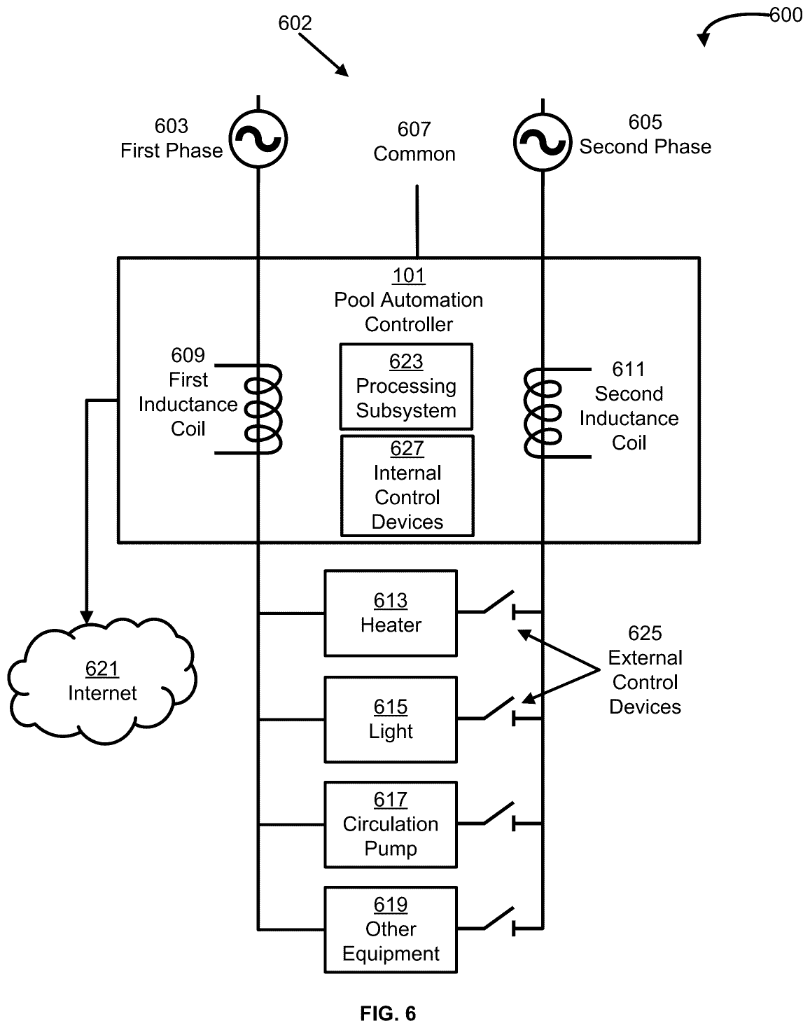

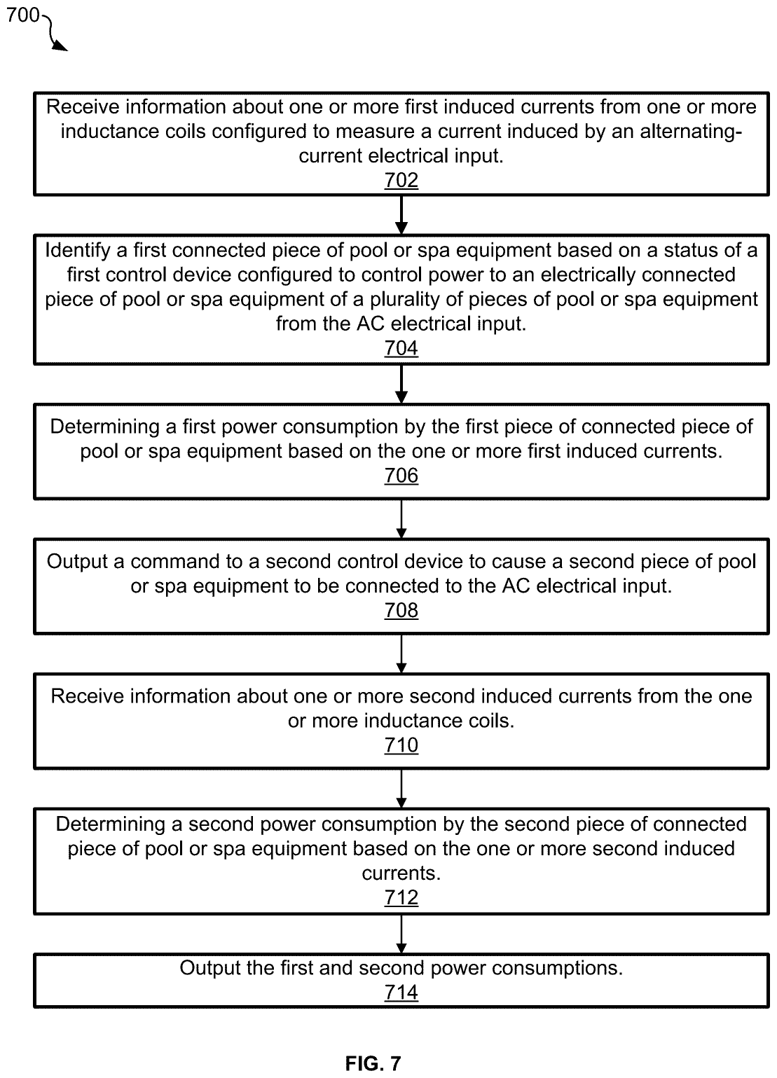

In another example, the pool automation controller 101 may include one or more inductance coils configured to measure a current induced by an AC electrical input. The pool automation controller 101 can receive information about one or more first induced currents from the one or more inductance coils for a piece of pool or spa equipment that is not necessarily connected to the pool automation controller 101 via the first electrical port or operated using a relay. For example, the piece of pool or spa equipment in this example may be digitally controlled or locally operated. The piece of pool or spa equipment can be identified based on the one or more first induced currents and again used to generate information that is useable to update the system status for the pool or spa system. Examples of systems and methods for detecting and/or identifying connected pool or spa equipment using AC induction are described below with respect to FIGS. 6 and 7.

Some pool or spa equipment may effectively function as the control device for that piece of pool or spa equipment. For example, for a piece of pool or spa equipment that is a temperature sensor, the first control device is the temperature sensor itself. This may be true for simple devices such as temperature sensors which can be temperature-sensitive resistors with little or no associated electronics. In such cases, the temperatures sensor itself is effectively the control device for the temperature sensor.

At block 208, the pool automation controller 101 records first information about the first control device. For example, the pool automation controller 101 may locally or remotely maintain a system status or list of control devices and associated connected pool or spa equipment. In some examples, a UI 111 provided by the pool automation controller 101 can be used to assign components to various nodes or locations in the system status. For example, the pool automation controller 101 may have identified and recorded which components are connected to the pool automation controller 101 but may still require roles to be assigned by a user. For instance, in the example depicted in FIG. 1, the pool automation controller 101 may deduce that, because two valve actuators 108, 110 are detected, the pool system 100 most likely contains both a pool and a spa. The UI 111 of the pool automation controller 101 may ask the user to assign the first valve actuator 108 and second valve actuator 110 to roles based on its assumption of the pool system 100 containing both a pool and a spa. The UI 111 of the pool automation controller 101 may also include options for correcting a falsely attributed layout of the pool system 100.

Assigning components from the UI 111 may further include assigning operating schedules to the components. For example, the UI 111 may allow the user to operate the first valve actuator 108 at a different schedule than the second valve actuator 110 or operate the first valve actuator 108 at different parameters than the second valve actuator 110.

In some examples, the first information can be recorded by outputting, to a client device, the first information. The client device may be, for example, a laptop, smartphone, tablet, etc. that is communicatively coupled with the pool automation controller 101 over a network using a protocol such as WiFi or Bluetooth. The client device may be executing client software for interfacing or controlling the pool automation controller 101. The client device can be used to view, create, or edit the system status described above.

Outputting the first information to the client device can cause the client device to generate a request for a mapping of the first piece of pool or spa equipment to the first control device using a user interface in order to make updates to the system status based on the identified control device. For instance, outputting the first information may cause the client device to execute program code to display a dialog box showing a graphical representation of the first information and requesting information or confirmation about an inferred mapping. The pool automation controller 101 then receives, from the client device, information about the mapping selected using the UI of the client device, in which the second information about the mapping is useable to update the system status for the pool or spa system.

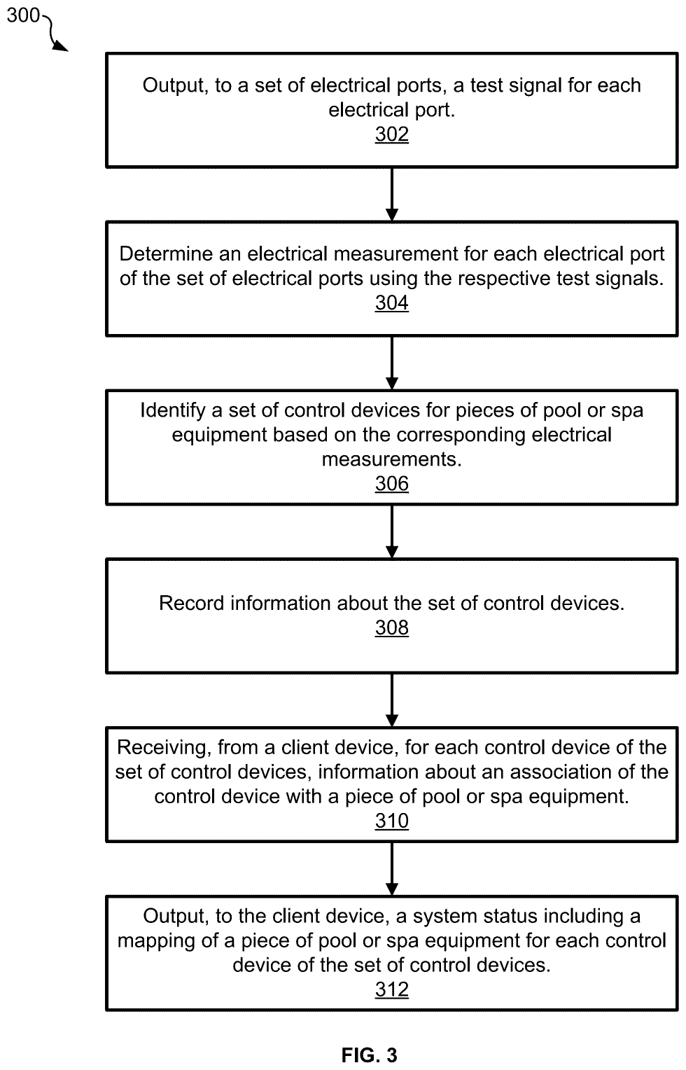

FIG. 3 illustrates an example flow diagram showing another process 300 for control device detection for pool or spa systems, according to some examples of the present disclosure. The process 300 is described from the perspective of a pool automation controller (e.g., the pool automation controller 101 of FIG. 1), but other computing systems such as an external control server or a client device can be used to perform some or all steps of the process 300.

This process, and any other processes described herein, is illustrated as a logical flow diagram, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The process 300 begins at block 302, a pool automation controller 101 outputs, to a set of electrical ports, a test signal for each electrical port. This block can proceed substantially as described with respect to block 202 above, except that the test signal is applied to a number of ports, serially or in parallel.

At block 304, the pool automation controller 101 determines an electrical measurement for each electrical port of the set of electrical ports using the respective test signals. This block can proceed substantially as described with respect to block 204 above, except that the determination can be made for each of the number of ports, serially or in parallel.

At block 306, the pool automation controller 101 identifies a set of control devices for pieces of pool or spa equipment based on the corresponding electrical measurements. This block can proceed substantially as described with respect to block 206 above, except that the identification of control devices can be made for each of the number of ports, serially or in parallel.

At block 308, the pool automation controller 101 records information about the set of control devices. This block can proceed substantially as described with respect to block 208 above, except that the record can be made for each of the number of ports, serially or in parallel.

At block 310, the pool automation controller 101 receives, from a client device, for each control device of the set of control devices, information about an association of the control device with a piece of pool or spa equipment. For example, the client device or the UI 111 can be used to provide an indication of a mapping between the identified control device and a particular piece of pool or spa equipment. The particular piece of pool or spa equipment can be inferred using information relating to the respective electrical measurement or it can be selected by the user using, for instance, an UI input control such as a drop down menu or search function.

At block 312, the pool automation controller 101 outputs, to the client device, a system status including a mapping of a piece of pool or spa equipment for each control device of the set of control devices. For example, using the associations made in block 310, a complete system status may now be available and can be output back to the pool automation controller 101 to locally store. The updated system status can be used by the pool automation controller 101 to provide telemetry, control, and operability for the pool or spa system via the UI 111.

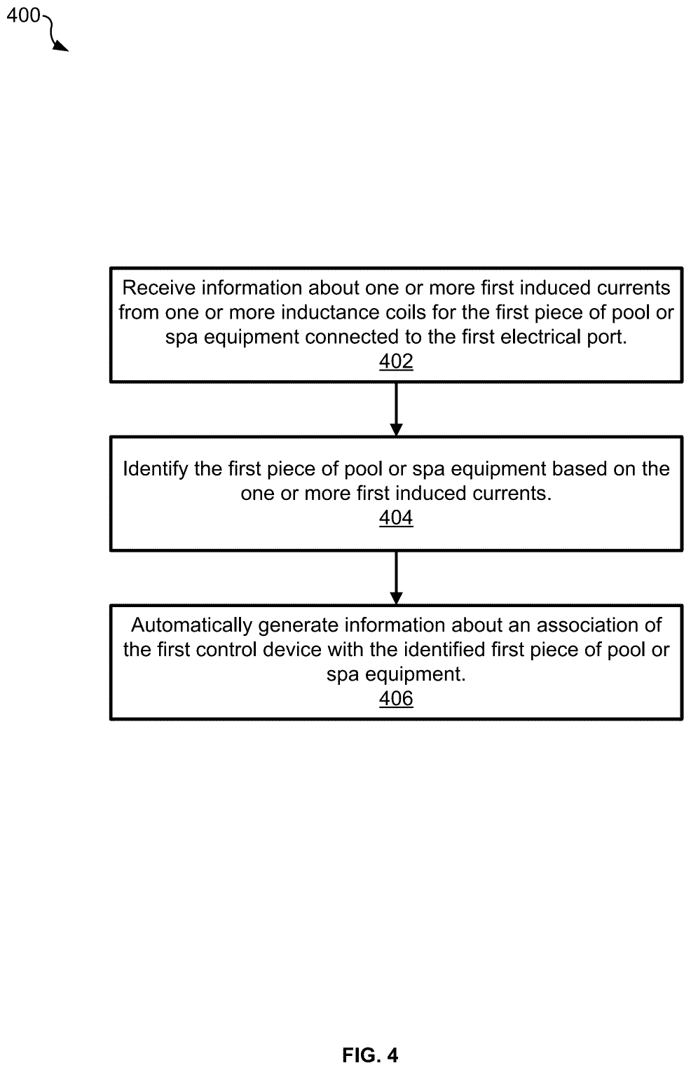

FIG. 4 illustrates an example flow diagram showing another process 400 for control device detection for pool or spa systems, according to some examples of the present disclosure. The process 400 is described from the perspective of a pool automation controller (e.g., the pool automation controller 101 of FIG. 1), but other computing systems such as an external control server or a client device can be used to perform some or all steps of the process 400.

This process, and any other processes described herein, is illustrated as a logical flow diagram, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The process 400 begins at block 402 and may follow the process 200, a pool automation controller 101 receives information about one or more first induced currents from one or more inductance coils for the first piece of pool or spa equipment connected to the first electrical port. For example, consider a piece of relay-switched pool or spa equipment such as a heater. The control device, a relay in this case, can turn the heater on or off as well as change the mode of operation of the heater. While the heater is on, the pool automation controller 101 can measure one or more induced currents in the induction coils. Thus, the pool automation controller 101 may now have information about the control device as well as the heater.

At block 404, the pool automation controller 101 identifies the first piece of pool or spa equipment based on the one or more first induced currents. For example, the one or more first induced currents may constitute an “electrical signature” that can be used to determine the identity of the first piece of pool or spa equipment or a characteristic thereof. For instance, a pattern of current draw or fluctuations specific to the particular piece of equipment can be used to identify the device. The measured induced currents can be compared to a database of known signatures or characteristics that can be used to identify the piece of equipment.

At block 406, the pool automation controller 101 automatically generates information about an association of the first control device with the identified first piece of pool or spa equipment. For example, the system status maintained by the pool automation controller 101 can be updated automatically using the identity or characteristic determined in block 404. The automatic update can reflect the particular identity of the first piece of pool or spa equipment or a less-specific change to the system status. For instance, the identification in block 404 may only determine that a pump has been connected to the system but may not be able to determine where.

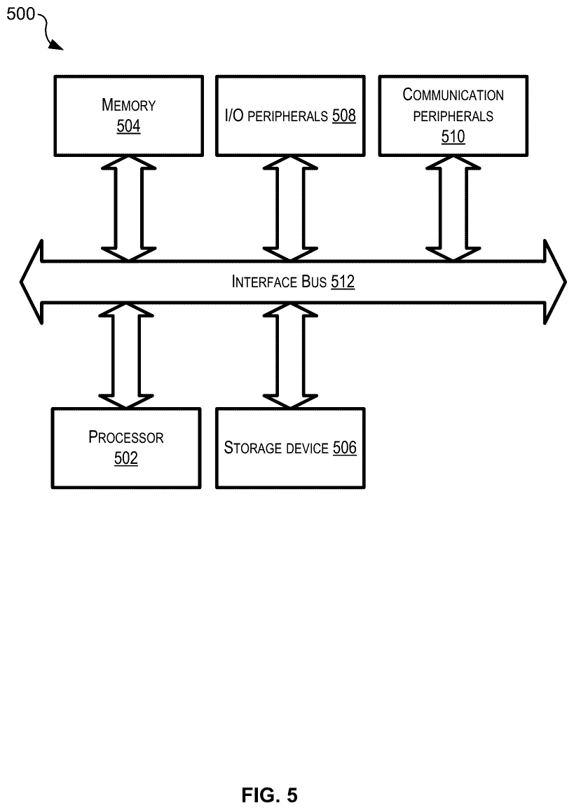

FIG. 5 illustrates examples of components of a computer system 500 used for control device detection for pool or spa systems, according to some examples of the present disclosure. The computer system 500 may be a single computer such as a user computing device and/or can represent a distributed computing system such as one or more server computing devices. The computer system 500 is an example of the external computing devices, controllers and/or microcontrollers of pool components and/or the pool system 100, and the like.

The computer system 500 may include at least a processor 502, a memory 504, a storage device 506, input/output peripherals (I/O) 508, communication peripherals 510, and an interface bus 512. The interface bus 512 is configured to communicate, transmit, and transfer data, controls, and commands among the various components of the computer system 500. The memory 505 and the storage device 506 include computer-readable storage media, such as Random Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program code embodying aspects of the disclosure. The memory 504 and the storage device 506 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 500.

Further, the memory 504 may include an operating system, programs, and applications. The processor 502 is configured to execute the stored instructions and includes, for example, a logical processing unit, a microprocessor, a digital signal processor, and other processors. The memory 504 and/or the processor 502 can be virtualized and can be hosted within another computing system of, for example, a cloud network or a data center. The I/O peripherals 508 may include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 508 are connected to the processor 502 through any of the ports coupled to the interface bus 512. The communication peripherals 510 are configured to facilitate communication between the computer system 500 and other computing devices over a communications network and include, for example, a network inference controller, modem, wireless and wired interface cards, antenna, and other communication peripherals.

Turning now to the figures, FIG. 6 illustrates a pool system 600 controlled by a pool automation controller 101 for control device detection for pool or spa systems, according to some examples of the present disclosure. The pool automation controller 101 includes a first inductance coil 609 for reading a first phase 603 of current and a second inductance coil 611 for reading a second phase 605 of current. The first and second coils 609 and 611 can be configured to measure the magnitude of AC electrical input 602 provided by the first phase 603, the second phase 605, and common line 607. In various configurations, the common line 607 may be referred to variously as the common, neutral, or ground line or wire.

The first inductance coil 609, second inductance coil 611, and other inductance coils may be disposed within the pool automation controller 101. For example, the pool automation controller 101 may include an external housing that contains the inductance coils 609, 611, processing subsystem 623, and a connection to the electrical input 602. The inductance coils 609, 611 may be any suitable inductance coil for measurement of the induced current associated with changing pool or spa equipment currents. Parameters such as coil inductance, current rating, frequency range, sensitivity, physical dimensions, and so on, may be selected in accordance with the particular application such as the expected electrical loading and current ranges (e.g., magnitude or time rate of change).

For some pool or spa systems, the electrical input 602 may be a residential or commercial AC electrical input. The electrical input 602 may be connected to the pool automation controller 101 such that the inductance coils 609 and 611 are contained within the pool automation controller 101. The electrical input 602 may be a split-phase AC electrical input including two hot wires (603 and 605) and a common (or neutral) wire (607), as shown in the example system 600. In that case, each of the two hot wires has a corresponding inductance coil, 609 and 111. In some other example systems, the electrical input 602 may be a single-phase AC electrical input including a single hot wire and a neutral wire, where the hot wire has a corresponding single inductance coil. Other electrical configurations involving AC electrical power can be used with the techniques describes herein including three-phase AC electrical input, variable frequency AC electrical input, and various AC configurations as may be implemented internationally.

The alternating-current for each of the first phase 603 and the second phase 605 pass through the respective coils 609 and 611 within the pool automation controller 101 causing an induced current in the coils 609 and 611. The induced current from the coils 609 and 611 can by digitized by the pool automation controller 101 and measured to compute the power consumption of the connected pieces of pool or spa equipment. For example, the coils 609 and 611 each can be connected to an amplifier and a digitizer (not shown). The digitizer can be used to make measurements of the current in each phase of the split-phase AC electrical input or other electrical configuration.

Power consumption can refer to the rate at which electrical energy is used or consumed by pool or spa equipment, sometimes measured in kilowatts or kilowatt-hours. Power consumption is a useful measure of electrical energy usage that may be used by utility providers or regulators for billing, computing tax rebates, and so forth. However, other measures of electrical energy usage that can be measured using induction may be likewise used with the techniques described herein.

The example system 600 depicts pool automation controller 101 supplying power to pool or spa equipment including a heater 613, a light 615, a circulation pump 617, and other equipment 619 of the pool system 600. These components are merely non-limiting examples and any suitable electrical device used for pool or spa operation, maintenance, monitoring, or other purpose may be similarly compatible with the system 600.

The pool or spa equipment is schematically shown connected in parallel to the hot wires (603, 605) of electrical input 602 using external control devices 625 and internal control devices 627. The internal and external control devices 625, 627 may be remotely operable mechanical actuators, electromechanical switches (e.g., solenoid controls), or other electrical or digital controls. For example, the internal and external control devices 625, 627 may include digital controls operated through an RS-485 serial communication link or other electronic or microprocessor-based control signals. In addition to the parallel connections depicted, the equipment may be connected in series or using more complex variations on series and parallel connections.

The pool automation controller 101 may include processing subsystem 623 for calculating power consumption based on induced currents read from the first coil 609 and the second coil 611 as well as other processing functions implemented using instructions. In some examples, the pool automation controller 101 may be connected to a standalone processing subsystem 623. The processing subsystem 623 may be a standalone circuit or may be implemented within the pool automation controller. In some examples, the processing subsystem 623 may be a hardware or software component of a computing system such as an embedded computer, mobile device, or a combination of such components. Likewise, some components of the system 600 may be hosted in a cloud-computing environment accessible over the internet 621, as described below. The processing subsystem 623 can be configured to executed program code in a memory using suitable software, hardware, firmware, or any combination thereof.

The internal and external control devices 625, 627 are controlled by processing subsystem 623 configured to control power to the pool or spa equipment. “Controlling power” can refer generally to various operations that change the power consumption of the equipment. For instance, controlling power can include turning equipment on or off (e.g., operating a power switch or button), connecting or disconnecting the equipment, operating a switch that closes or opens an energized circuit, or changes a mode of operation (e.g., throttling power, changing speeds, varying modes, etc.). The internal and external control devices 625, 627 may include relays such as electromechanical relays, solid-state relays, and the like. The relays can be used to actuate remotely controlled mechanical actuators, electromechanical switches, and so on. The internal and external control devices 625, 627 may also include a digital controller that controls power directed to the pool or spa equipment through an RS-485 serial controller, Ethernet controller, microprocessor controller, etc. In some examples, the internal control devices 627 may be located inside the pool automation controller 101 housing.

The pool automation controller 101 is also connected to the internet 621, which may enable connectivity to a server with information related to power utility rates, peak energy rate usage, specified power consumption of replacement pool equipment, algorithms for optimizing power consumption, algorithms for optimizing performance, and other information related to power consumption of the pool system 600.

In some examples, information induced currents obtained using the inductance coils 609, 611 can be used to identify connected pieces of pool or spa equipment. For example, a piece of pool or spa equipment connected to the pool automation controller 101 via an internal or external control device 625, 627 can be identified using an “electronic signature” measured using the inductance coils 609, 611. Alternatively, for a piece of pool or spa equipment that is not connected using the internal or external control device 625, 627, the “electronic signature” measured using the inductance coils 609, 611 can likewise be used to identify the equipment.

This system may be used for load sensing of electrical loads of the system. The processing circuitry may be a standalone circuit or may be implemented within the pool automation controller. The line input wiring (e.g., two phases) may be wired through each of the first coil and the second coil that are part of the pool automation controller. The processing circuitry may take outputs from the coils, which may be processed to measure current flow and then measure power and pass them to the pool automation controller for additional processing. Using this arrangement, the pool automation controller to selectively power on and off certain pieces of equipment to derive an electrical “signature” of each. This electrical signature can be used to detect equipment with relatively higher loads that are not digitally connected to the pool automation controller, as compared to loads that are detected using current flow and/or voltage drop techniques. In a particular example, the pool automation controller may use the energy measurement system to selectively measure energy consumption of individual pieces of pool equipment.

FIG. 7 illustrates an example flow diagram showing a process 700 for equipment detection and identification using load sensing for pool or spa systems, according to some examples of the present disclosure. The process 700 is described from the perspective of a pool automation controller (e.g., the pool automation controller 101 of FIG. 1), but other computing systems such as an external control server or a client device can be used to perform some or all steps of the process 700.

This process, and any other processes described herein, is illustrated as a logical flow diagram, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

In some examples, the process 700 may be combined with the process 200 and performed by the pool automation controller 101. This may include performing the two techniques in parallel and/or in serial. For example, the load sensing technique described with reference to FIG. 6 and this process 700 may be performed to identify the higher power equipment. Afterwards, the current draw and/or voltage drop techniques described with reference to FIG. 1 and processes 200 and 300 may be performed to identify the remaining pieces of equipment (e.g., those that draw lower power than the ones identified by the load sensing technique). A single pool automation controller 101 may therefore include the software, firmware, and/or hardware to perform these methods, communicate with other system elements, and the like.

At block 702, a computing system, such as the processing subsystem 623 shown in example system 600 of FIG. 6, receives information about one or more first induced currents from one or more inductance coils configured to measure a current induced by an AC electrical input. For example, the system 600 includes two inductance coils 609 and 611, but other configurations involving one, three, or other numbers of inductance coils can be used in the context of process 700.

The information about the induced currents may be received by way of an analog-to-digital conversion (“ADC”) in which the analog induced currents are converted into digital signals using a sampling process that quantizes the continuous analog signal into discrete digital values. This digital data can then be processed by the processing subsystem 623 to perform various power consumption measurements as described below to enable precision control and monitoring of the system 600.

At block 704, the computing system identifies a first connected piece of pool or spa equipment based on a status of a first control device configured to control power to an electrically connected piece of pool or spa equipment of a plurality of pieces of pool or spa equipment from the AC electrical input. For example, the first piece of equipment may be a heater that is connected to the two phases of an AC electrical input. The heater may be connected by way of a remotely operated relay, such as a solid-state relay or an electromechanical relay, which allows the heater to be powered on or off remotely by, for example, the processing subsystem 623 using an internal or external control device 625, 627. Controlling power to the electrically connected piece of equipment can include turning power on or off (e.g., operating a power switch or button), connecting/disconnecting a mechanical switch, operating an electronic switch to start or stop current in a circuit, changing the mode of a piece of equipment using a relay or digital control, and so on. The status of the remotely operable relay can be ascertained using an electrical relay (e.g., an energized solenoid), a digital signal, and so on. In some examples, the status of the remotely operable relay may be based on the associated status of the internal or external control device 625, 627. For example, the status of the relay may be based on the corresponding status of a digital controller that controls the relay.

At block 706, the computing system determines a first power consumption by the first piece of connected piece of pool or spa equipment based on the one or more first induced currents. In some examples, the first power consumption can be computed using a difference in the measured induced current. For instance, the processing subsystem 623 can derive the power consumption of the first pool equipment by powering down the first pool equipment and monitoring the resulting change in induced current. In another example, the processing subsystem 623 can derive the power consumption of the first pool equipment by powering down all other pool equipment and measuring the remaining induced current.

In some examples, measuring the power consumption of equipment of a pool or spa system may be performed according to a switching algorithm executed by the processing subsystem 623. A “switching algorithm” may refer generally to a series of instructions for making power consumption measurements. The processing subsystem 623 may measure the power consumption of equipment by taking current measurements with the first coil 609 and second coil 611 of the pool automation controller 101 and derive power consumption from the current measurements. The processing subsystem 623 may take such measurements by recording changes in the first phase 603 and second phase 605 of an alternating current used to power the pool or spa system. Such changes may occur as equipment is switched on and off using the internal or external control device 625, 627 according to the algorithm executed by the processing subsystem 623.

For instance, an example algorithm for measuring the power consumption of pool equipment may involve powering down all equipment, then powering on individual items of equipment one at a time to record the changes in current through the coils. Alternatively, an example algorithm may involve powering on all equipment, then powering down individual equipment one at a time to record the changes in current through the coils. Other algorithms or processes for deducing the power consumption of individual pieces of equipment are also possible. The pool automation controller 101 may control power to some equipment by actuating a relay to operate a remote switch (e.g., a solenoid control or electromechanical actuator) and some equipment by digital signal. In the latter case, a piece of pool or spa equipment may include local electronic or microprocessor control that can be remotely signaled using a digital control interface through an RS-485 serial controller or the like.

Switching algorithms can likewise be used for various aggregate or derivative calculations. For instance, the measurements of the power consumption measurement plan can be combined to compute an aggregate power consumption measurement that indicates the power consumption of all or a subset of all of the pieces of pool or spa equipment. In an example of an aggregate or derivative operation, the processing subsystem can be used to determine the power consumption of particular modes of operation of pieces of pool equipment. For example, a first piece of pool or spa equipment can be configured to operate in a first mode of operation. For instance, a pump 617 can be set at a first speed. The operations described above can be used to determine a power consumption at the first setting. Then, the piece of pool or spa equipment can be configured to operate in a second mode of operation, such as a pump 617 at a higher or lower speed. The mode of operation can be changed using an internal or external control device 625, 627 such as a relay or digital controller to remotely change the mode of operation and thereby control power to the equipment. The operations described above can again be used to determine a power consumption based on one or more induced currents. The power consumption of the mode of operation can then be determined by the processing subsystem 623 based on a difference between the power consumption before and after changing the mode of operation. For instance, if the power consumption of the pump 617 is measured first at a high speed and then at a low speed, the difference in power consumption can be used to determine the power consumption at the high temperature and/or the low temperature.

In one example, the pool automation controller 101 may instruct all equipment, except a circulation pump, to power down such that the circulation pump is the only equipment drawing power. The pool automation controller 101 may then use the energy measurement circuit to measure current flow through the first inductance coil 609 and the second inductance coil 611 over a fixed time interval. After recording a measurement for the energy consumption of the circulation pump, the pool automation controller 101 may power down the circulation pump, power on a water heater, and repeat the process to derive the energy consumption of the water heater. The pool automation controller 101 may also measure energy consumption at a different level of granularity than just on and off. For example, when isolating a pump to measure power, the pump may be operated at different modes for more precise characterization such as at different speeds. Additional signals about system status may also be considered such as how the valves are set to include the contribution of various back pressure effects are applied to the system. In this manner, the pool automation controller 101 can determine not only how different modes/states of a piece of equipment might impact energy consumption (e.g., adjusting speeds of a pump), but also how other items in the system that are separate from the piece of equipment might impact energy consumption of the piece of equipment (e.g., how a valve settings in the system may impact power consumption of a pump at each of a variety of speeds).

Other examples of power consumption measurements for modes of operation for pieces of pool or spa equipment that can be measured include power consumption for circulation pump speed (e.g., RPMs), lighting system settings, filtration system modes, automated cleaning system status, and so on.

At block 708, the computing system outputs a command to a second control device to cause a second piece of pool or spa equipment to be connected to the AC electrical input. For example, the second control device may be a relay or digital controller that controls power to the second piece of pool or spa equipment using a switch or remotely operated digital control.

At block 710, the computing system receives information about one or more second induced currents from the one or more inductance coils. This measurement can proceed substantially as the measurement described above in block 702. In some examples, different pieces of pool or spa equipment may be connected to the AC electrical input using a different wiring scheme, in which case a different measurement procedure can be followed.

At block 712, the computing system determines a second power consumption by the second piece of connected piece of pool or spa equipment based on the one or more second induced currents. The second power consumption can be based on a difference between the first and second induced currents.

At block 714, the computing system outputs the first and second power consumptions. For example, the first and second power consumptions can be displayed using an appropriate user interface (“UI”) such as an external display of the pool automation controller 101 or a suitable graphical user interface (“GUI”) accessible using the pool automation controller 101. In some examples, the first and second power consumptions can be output to a remote server and displayed on a GUI such as a web page accessible over the internet 621.

The operations described above for blocks 702-714 can be repeated as needed for other pieces of equipment. For example, to measure the power consumption for a third piece of equipment, the computing system can output commands to the internal or external control devices 625, 627 to cause the first or second pieces of pool or spa equipment to be disconnected or otherwise unpowered from the AC electrical input. Then the computing system can output additional commands to the internal or external control devices 625, 627 to cause a third piece of pool or spa equipment to be connected or otherwise powered to the AC electrical input and/or to cause all other pieces of pool or spa equipment to be disconnected or otherwise unpowered from the AC electrical input. The power consumption of the third piece of pool or spa equipment based on one or more third induced currents can then be measured using, for example, a measured difference in the induced current.

Measuring the energy consumption of pool or spa equipment by measuring current flow at the pool automation controller 101 may obviate the need to install additional electronics that would otherwise be needed to measure the energy consumption of individual equipment. Many items of pool or spa equipment are not equipped with electronics capable of recording or reporting the component's energy consumption. Installing additional electronics on these pool or spa equipment may be expensive and impractical, especially if the items of equipment are underground. While the pool automation controller 101 may be able to measure the energy consumption of equipment without receiving a signal directly from the equipment, the pool automation controller may also be able to receive reports of energy consumption from equipment that are capable of reporting energy consumption. In such an example, the pool automation controller 101 may make recommendations that consider both energy consumption information derived from the energy measurement circuit of the pool automation controller as well as data from pool or spa equipment.

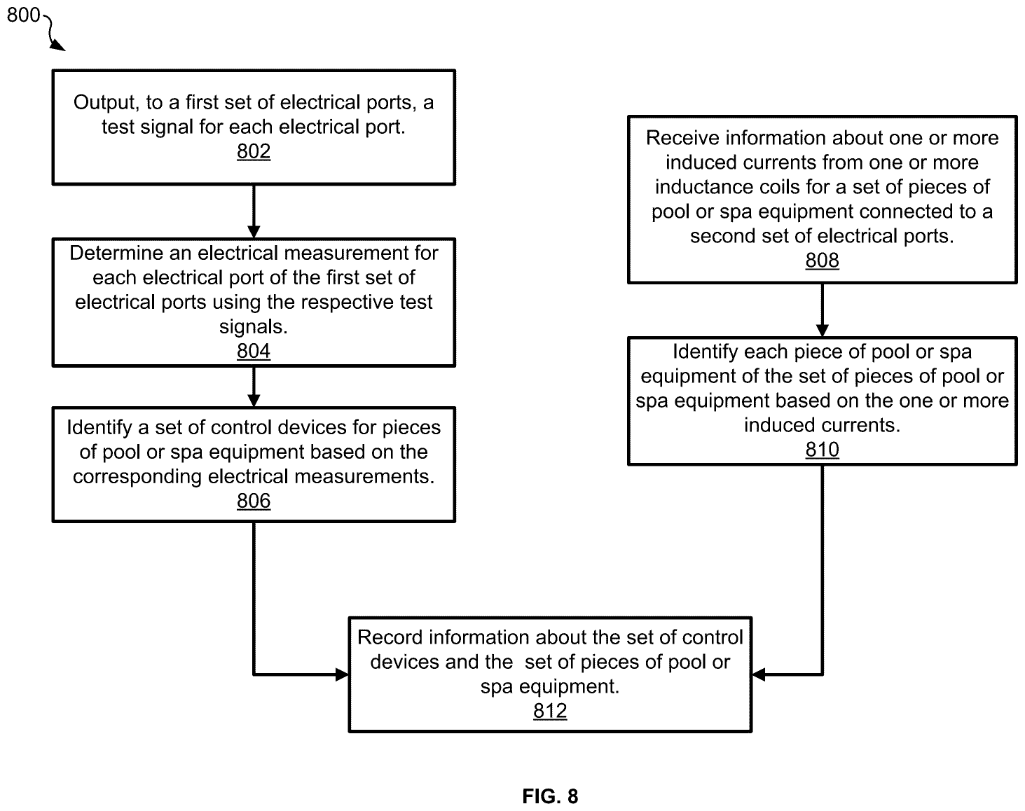

FIG. 8 illustrates an example flow diagram showing a process 800 for equipment detection and identification using a combination of techniques for pool or spa systems, according to some examples of the present disclosure. The process 800 is described from the perspective of a pool automation controller (e.g., the pool automation controller 101 of FIG. 1), but other computing systems such as an external control server or a client device can be used to perform some or all steps of the process 800.

This process, and any other processes described herein, is illustrated as a logical flow diagram, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

As described above, the process 700 may be combined with the process 200 and performed by the pool automation controller 101 such as by performing the two techniques in parallel and/or in serial. This example process 800 illustrates one such combination. At block 802, a pool automation controller 101 outputs, to a first set of electrical ports, a test signal for each electrical port. In this example, the pool automation controller 101 includes a number of electrical ports to which various kinds of pool or spa equipment may be connected. For example, equipment types according to the three groups (e.g., low power loads, medium power loads, and high power loads) described above may be connected. Block 802 can proceed substantially as described with respect to block 302 in FIG. 3 above for detecting or identifying low or medium power loads connected to the first set of electrical ports.

At block 804, the pool automation controller 101 determines an electrical measurement for each electrical port of the first set of electrical ports using the respective test signals. Block 804 can proceed substantially as described with respect to block 304 in FIG. 3. In some examples, the test signals may be output to all electrical ports in cases in which the type of connected equipment is unknown to the pool automation controller 101.

At block 806, the pool automation controller 101 identifies a set of control devices for pieces of pool or spa equipment based on the corresponding electrical measurements. Block 806 can proceed substantially as described with respect to block 306 in FIG. 3. This identification may proceed for electrical ports for which a corresponding electrical measurement can be made. For some electrical ports, the electrical response may differ significantly from an expected profile, indicating that a high power load is connected, no load is connected, or a loss of connectivity exists in the connecting wires.

At block 808, in parallel (e.g., substantially simultaneously with blocks 802-806), the pool automation controller 101 receives information about one or more induced currents from one or more inductance coils for a set of pieces of pool or spa equipment connected to a second set of electrical ports. Block 808 can proceed substantially as described with respect to block 402 in FIG. 4, except that in this example the pool automation controller 101 can measure induced currents for several different pieces of equipment. For instance, the pool automation controller 101 can cycle through the equipment connected to the second set of electrical ports, one piece of equipment at a time.

At block 810, the pool automation controller 101 identifies each piece of pool or spa equipment of the set of pieces of pool or spa equipment based on the one or more induced currents. Block 810 can proceed substantially as described with respect to block 404 in FIG. 4, except again, the pieces can be identified as the pool automation controller 101 cycles through the connected equipment, taking individual measurements for each connected piece of equipment.

Various cycling algorithms can be used according to particular applications including sequential polling, in which the pool automation controller 101 tests each piece of equipment in a predefined order, or priority-based cycling, in which pieces of equipment with higher operational significance (e.g., connected to certain ports) can be measured more frequently. Some examples may use adaptive algorithms that can adjust the cycling sequence based on historical current patterns or equipment status.

At block 812, the pool automation controller 101 records information about the set of control devices and the set of pieces of pool or spa equipment. For example, either while the measurements of blocks 802-806 and 808-810 are occurring or following their completion, the information about the detected or identified control devices and pieces of pool or spa equipment that can ephemerally or persistently stored by the pool automation controller 101. The information can be used to automatically update a system status or to provide inputs or prompts to a user interface to enable a maintainer of the pool or spa system to update the system status.

### General Considerations

The examples described herein are not intended to be mutually exclusive, exhaustive, or restrictive in any way, and the disclosure is not limited to these example embodiments but rather encompasses all possible modifications and variations within the scope of any claims ultimately drafted and issued in connection with the disclosure (and their equivalents). For avoidance of doubt, any combination of features not physically impossible or expressly identified as non-combinable herein may be within the scope of the disclosure. Finally, references to “pools” and “swimming pools” herein may also refer to spas or other water containing vessels used for recreation, training, or therapy.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Although applicant has described devices and techniques for use principally with swimming pools and spas, persons skilled in the relevant field will recognize that the present invention may be employed in connection with other objects and in other manners. Finally, references to “pools” and “swimming pools” herein may also refer to spas or other water containing vessels used for recreation or therapy and for which cleaning is needed or desired.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

### Examples

A collection of exemplary embodiments is provided below, including at least some explicitly enumerated as “Examples” providing additional description of a variety of example embodiments in accordance with the concepts described herein. These examples are not meant to be mutually exclusive, exhaustive, or restrictive; and the disclosure is not limited to these examples but rather encompasses all possible modifications and variations within the scope of the issued claims and their equivalents.

As used below, any reference to a series of examples is to be understood as a reference to each of those examples disjunctively (e.g., “Examples 1-4” is to be understood as “Examples 1, 2, 3, or 4”).

Example 1 is a pool automation controller for detecting electrical components of a pool or spa system, comprising: one or more electrical ports, each electrical port configured to receive a connection to a control device associated with a piece of pool or spa equipment; one or more non-transitory computer-readable media; and one or more processors communicatively coupled to the one or more non-transitory computer-readable media, the one or more processors configured to execute processor-executable instructions stored in the non-transitory computer-readable media to perform operations including: outputting, to a first electrical port, a test signal; determining an electrical measurement for the first electrical port using the test signal; identifying a first control device for a first piece of pool or spa equipment based on the electrical measurement; and recording first information about the first control device.

Example 2 is the pool automation controller of example(s) 1, wherein recording the first information about the first control device comprises: outputting, to a client device, the first information to cause the client device to generate a request for second information about a mapping of the first piece of pool or spa equipment to the first control device using a user interface; and receiving, from the client device, the second information about the mapping, wherein the second information about the mapping is useable to update a system status for the pool or spa system.

Example 3 is the pool automation controller of any one or more of the above example(s), wherein the one or more processors are configured to execute additional processor-executable instructions stored in the non-transitory computer-readable media to perform additional operations comprising: outputting, to a plurality of electrical ports, a test signal for each electrical port; determining an electrical measurement for each electrical port of the plurality of electrical ports using the respective test signals; identifying a plurality of control devices for pieces of pool or spa equipment based on the corresponding electrical measurements; recording second information about the plurality of control devices; receiving, from a client device, for each control device of the plurality of control devices, information about an association of the control device with a piece of pool or spa equipment; and outputting, to the client device, a system status including a mapping of a piece of pool or spa equipment for each control device of the plurality of control devices.

Example 4 is the pool automation controller of any one or more of the above example(s), further comprising a digital interface and wherein the one or more processors are configured to execute additional processor-executable instructions stored in the non-transitory computer-readable media to perform additional operations comprising: receiving second information about a second piece of pool or spa equipment, wherein the second piece of pool or spa equipment is communicatively coupled with the pool automation controller via the digital interface; and recording third information about the second piece of pool or spa equipment, wherein the third information is useable to update a system status for the pool or spa system.

Example 5 is the pool automation controller of any one or more of the above example(s), further comprising one or more inductance coils configured to measure a current induced by an alternating-current (“AC”) electrical input, and wherein the one or more processors are configured to execute additional processor-executable instructions stored in the non-transitory computer-readable media to perform additional operations comprising: receiving second information about one or more first induced currents from the one or more inductance coils for a second piece of pool or spa equipment; identifying the second piece of pool or spa equipment based on the one or more first induced currents; and recording third information about the second piece of pool or spa equipment, wherein the third information is useable to update a system status for the pool or spa system.

Example 6 is the pool automation controller of any one or more of the above example(s), wherein the test signal is output to the first electrical port in response to a triggering event, the triggering event being one of: a startup of the pool automation controller; an expiration of a periodically occurring predetermined period of time; or a detection of a connection to the first electrical port.

Example 7 is the pool automation controller of any one or more of the above example(s), wherein: the first control device is a valve actuator; and the first piece of pool or spa equipment is a valve configured to direct flow of water to or from a body of water associated with the pool or spa system.

Example 8 is the pool automation controller of any one or more of the above example(s), wherein: the first control device is an electromechanical relay; and the first piece of pool or spa equipment is one of a pump, a heater, or a light.

Example 9 is the pool automation controller of any one or more of the above example(s), wherein: the first piece of pool or spa equipment is a temperature sensor; and the first control device is the temperature sensor.

Example 10 is the pool automation controller of any one or more of the above example(s), wherein the one or more processors are configured to execute additional processor-executable instructions stored in the non-transitory computer-readable media to perform an additional operation comprising: determining, based on the first information about the first control device, a type of the first piece of pool or spa equipment based, wherein the type is one of a valve, a pump, a heater, or a light.

Example 11 is the pool automation controller of any one or more of the above example(s), wherein: outputting, to the first electrical port, the test signal comprises applying a predetermined voltage across one or more terminals of the first electrical port to cause a current in a circuit including the one or more terminals of the first electrical port and the first control device; and the electrical measurement for the first electrical port is one of a first measurement of the current in the circuit or a second measurement of a voltage drop based on at least one voltage determined using the one or more terminals of the first electrical port.

Example 12 is the pool automation controller of any one or more of the above example(s), wherein the test signal is applied for a predetermined first duration, the predetermined first duration being less than a second duration required to activate the first piece of pool or spa equipment.

Example 13 is the pool automation controller of any one or more of the above example(s), further comprising one or more inductance coils configured to measure a current induced by an alternating-current (“AC”) electrical input and wherein the one or more processors are configured to execute additional processor-executable instructions stored in the non-transitory computer-readable media to perform additional operations comprising: receiving information about one or more first induced currents from the one or more inductance coils for the first piece of pool or spa equipment connected to the first electrical port; identifying the first piece of pool or spa equipment based on the one or more first induced currents; and automatically generating information about an association of the first control device with the identified first piece of pool or spa equipment.

Example 14 is a method, comprising: outputting, to a first electrical port, a test signal; determining an electrical measurement for the first electrical port using the test signal; identifying a first control device for a first piece of pool or spa equipment based on the electrical measurement; and recording first information about the first control device.

Example 15 is the method of example(s) 14, further comprising: outputting, to a client device, the first information to cause the client device to generate a request for second information about a mapping of the first piece of pool or spa equipment to the first control device using a user interface; and receiving, from the client device, the second information about the mapping, wherein the second information about the mapping is useable to update a system status for the pool or spa system.

Example 16 is the method of any one or more of the above example(s), further comprising: outputting, to a plurality of electrical ports, a test signal for each electrical port; determining an electrical measurement for each electrical port of the plurality of electrical ports using the respective test signals; identifying a plurality of control devices for pieces of pool or spa equipment based on the corresponding electrical measurements; recording second information about the plurality of control devices; receiving, from a client device, for each control device of the plurality of control devices, information about an association of the control device with a piece of pool or spa equipment; and outputting, to the client device, a system status including a mapping of a piece of pool or spa equipment for each control device of the plurality of control devices.

Example 17 is the method of any one or more of the above example(s), wherein: the first control device is a valve actuator; and the first piece of pool or spa equipment is a valve configured to direct flow of water to or from a body of water associated with the pool or spa system.

Example 18 is the method of any one or more of the above example(s), wherein: the first control device is an electromechanical relay; and the first piece of pool or spa equipment is one of a pump, a heater, or a light.

Example 19 is the method of any one or more of the above example(s), wherein the test signal is applied for a predetermined first duration, the predetermined first duration being less than a second duration required to activate the first piece of pool or spa equipment.

Example 20 is a non-transitory computer-readable medium storing processor-executable instructions configured to cause one or more processors to: output, to a first electrical port, a test signal; determine an electrical measurement for the first electrical port using the test signal; identify a first control device for a first piece of pool or spa equipment based on the electrical measurement; and record first information about the first control device.

What is claimed is:

1. A pool automation controller for detecting electrical components of a pool or spa system, comprising:
one or more electrical ports, each electrical port configured to receive a connection to a control device associated with a piece of pool or spa equipment;
one or more non-transitory computer-readable media; and
one or more processors communicatively coupled to the one or more non-transitory computer-readable media, the one or more processors configured to execute processor-executable instructions stored in the non-transitory computer-readable media to perform operations including:
outputting, to a first electrical port, a test signal;
determining an electrical measurement for the first electrical port using the test signal;
identifying a first control device for a first piece of pool or spa equipment based on the electrical measurement; and
recording first information about the first control device.

2. The pool automation controller of claim 1, wherein recording the first information about the first control device comprises:
outputting, to a client device, the first information to cause the client device to generate a request for second information about a mapping of the first piece of pool or spa equipment to the first control device using a user interface; and
receiving, from the client device, the second information about the mapping, wherein the second information about the mapping is useable to update a system status for the pool or spa system.

3. The pool automation controller of claim 1, wherein the one or more processors are configured to execute additional processor-executable instructions stored in the non-transitory computer-readable media to perform additional operations comprising:
outputting, to a plurality of electrical ports, a test signal for each electrical port;
determining an electrical measurement for each electrical port of the plurality of electrical ports using the respective test signals;
identifying a plurality of control devices for pieces of pool or spa equipment based on the corresponding electrical measurements;
recording second information about the plurality of control devices;
receiving, from a client device, for each control device of the plurality of control devices, information about an association of the control device with a piece of pool or spa equipment; and
outputting, to the client device, a system status including a mapping of a piece of pool or spa equipment for each control device of the plurality of control devices.

4. The pool automation controller of claim 1, further comprising a digital interface and wherein the one or more processors are configured to execute additional processor-executable instructions stored in the non-transitory computer-readable media to perform additional operations comprising:
receiving second information about a second piece of pool or spa equipment, wherein the second piece of pool or spa equipment is communicatively coupled with the pool automation controller via the digital interface; and
recording third information about the second piece of pool or spa equipment, wherein the third information is useable to update a system status for the pool or spa system.

5. The pool automation controller of claim 1, further comprising one or more inductance coils configured to measure a current induced by an alternating-current (“AC”) electrical input, and wherein the one or more processors are configured to execute additional processor-executable instructions stored in the non-transitory computer-readable media to perform additional operations comprising:
receiving second information about one or more first induced currents from the one or more inductance coils for a second piece of pool or spa equipment;
identifying the second piece of pool or spa equipment based on the one or more first induced currents; and
recording third information about the second piece of pool or spa equipment, wherein the third information is useable to update a system status for the pool or spa system.

6. The pool automation controller of claim 1, wherein the test signal is output to the first electrical port in response to a triggering event, the triggering event being one of: a startup of the pool automation controller; an expiration of a periodically occurring predetermined period of time; or a detection of a connection to the first electrical port.

7. The pool automation controller of claim 1, wherein:
the first control device is a valve actuator; and
the first piece of pool or spa equipment is a valve configured to direct flow of water to or from a body of water associated with the pool or spa system.

8. The pool automation controller of claim 1, wherein:
the first control device is an electromechanical relay; and
the first piece of pool or spa equipment is one of a pump, a heater, or a light.

9. The pool automation controller of claim 1, wherein:
the first piece of pool or spa equipment is a temperature sensor; and
the first control device is the temperature sensor.

10. The pool automation controller of claim 1, wherein the one or more processors are configured to execute additional processor-executable instructions stored in the non-transitory computer-readable media to perform an additional operation comprising:
determining, based on the first information about the first control device, a type of the first piece of pool or spa equipment based, wherein the type is one of a valve, a pump, a heater, or a light.

11. The pool automation controller of claim 1, wherein:
outputting, to the first electrical port, the test signal comprises applying a predetermined voltage across one or more terminals of the first electrical port to cause a current in a circuit including the one or more terminals of the first electrical port and the first control device; and
the electrical measurement for the first electrical port is one of a first measurement of the current in the circuit or a second measurement of a voltage drop based on at least one voltage determined using the one or more terminals of the first electrical port.

12. The pool automation controller of claim 1, wherein the test signal is applied for a predetermined first duration, the predetermined first duration being less than a second duration required to activate the first piece of pool or spa equipment.

13. The pool automation controller of claim 1, further comprising one or more inductance coils configured to measure a current induced by an AC electrical input and wherein the one or more processors are configured to execute additional processor-executable instructions stored in the non-transitory computer-readable media to perform additional operations comprising:
receiving information about one or more first induced currents from the one or more inductance coils for the first piece of pool or spa equipment connected to the first electrical port;
identifying the first piece of pool or spa equipment based on the one or more first induced currents; and
automatically generating information about an association of the first control device with the identified first piece of pool or spa equipment.

14. A method, comprising:
outputting, to a first electrical port, a test signal;
determining an electrical measurement for the first electrical port using the test signal;
identifying a first control device for a first piece of pool or spa equipment based on the electrical measurement; and
recording first information about the first control device.

15. The method of claim 14, further comprising:
outputting, to a client device, the first information to cause the client device to generate a request for second information about a mapping of the first piece of pool or spa equipment to the first control device using a user interface; and
receiving, from the client device, the second information about the mapping, wherein the second information about the mapping is useable to update a system status for the pool or spa system.

16. The method of claim 14, further comprising:
outputting, to a plurality of electrical ports, a test signal for each electrical port;
determining an electrical measurement for each electrical port of the plurality of electrical ports using the respective test signals;
identifying a plurality of control devices for pieces of pool or spa equipment based on the corresponding electrical measurements;
recording second information about the plurality of control devices;
receiving, from a client device, for each control device of the plurality of control devices, information about an association of the control device with a piece of pool or spa equipment; and
outputting, to the client device, a system status including a mapping of a piece of pool or spa equipment for each control device of the plurality of control devices.

17. The method of claim 14, wherein:
the first control device is a valve actuator; and
the first piece of pool or spa equipment is a valve configured to direct flow of water to or from a body of water associated with the pool or spa system.

18. The method of claim 14, wherein:
the first control device is an electromechanical relay; and
the first piece of pool or spa equipment is one of a pump, a heater, or a light.

19. The method of claim 14, wherein the test signal is applied for a predetermined first duration, the predetermined first duration being less than a second duration required to activate the first piece of pool or spa equipment.

20. A non-transitory computer-readable medium storing processor-executable instructions configured to cause one or more processors to:
output, to a first electrical port, a test signal;
determine an electrical measurement for the first electrical port using the test signal;
identify a first control device for a first piece of pool or spa equipment based on the electrical measurement; and
record first information about the first control device.
